(19) United States
(12) Patent Application Publication
(10) Pub. No.: US 2013/0336608 A1
(43) Pub. Date: Dec. 19, 2013

(54) BEARING ASSEMBLY FOR USE WITH A TURBINE ENGINE

(71) Applicant: GENERAL ELECTRIC COMPANY, Schenectady, NY (US)

(72) Inventors: Jacob Patrick Miller, Sharonville, OH (US); Bruce Alan Carter, West Chester, OH (US); Michael Gilbert Johnson, Fairfield, OH (US); Gary Paul Moscarino, Cincinnati, OH (US); David William Pugh, Fairfield, OH (US); Jonothan Allen Scheetz, Waynesville, OH (US); Thomas DeWitt Woodrow, Wyoming, OH (US)

(73) Assignee: General Electric Company, Schenectady, NY (US)

(21) Appl. No.: 13/786,528

(22) Filed: Mar. 6, 2013

Related U.S. Application Data
(60) Provisional application No. 61/660,293, filed on Jun. 15, 2012.

(51) Int. Cl. F16C 33/66; F16C 33/32; F16C 19/04

(52) U.S. Cl. CPC F16C 33/6659; F16C 19/04; F16C 33/32
USPC 384/475; 384/492

(57) ABSTRACT

Bearing assemblies, such as for use with a turbine engine, are disclosed. An example the bearing assembly may include an outer ring comprising an oil drainage aperture defined therein; an inner ring disposed coaxially within the outer ring, the inner ring including an oil supply aperture defined therein; and a plurality of rolling elements engaged between the outer ring and the inner ring, wherein the plurality of rolling elements are constructed of a ceramic material.

### CROSS REFERENCE TO RELATED APPLICATION

This application claims the benefit of U.S. Provisional Application No. 61/660,293, filed Jun. 15, 2012, which is incorporated by reference herein in its entirety.

### BACKGROUND

The subject matter disclosed herein relates generally to turbine engines and, more specifically, to bearing assemblies for supporting turbine rotor shafts.

At least some known gas turbine engines include a forward fan, a core engine, and a power turbine coupled together in serial flow relationship. The core engine includes at least one compressor, a combustor, and a high-pressure turbine. More specifically, the compressor and high-pressure turbine are coupled through a shaft to define a high-pressure rotor assembly. Air entering the core engine is compressed, mixed with fuel, and ignited to form a high energy gas stream. The high energy gas stream is directed through the high-pressure turbine to rotatably drive the high-pressure turbine such that the shaft rotatably drives the compressor.

These known rotating shafts transfer power and rotary motion from the turbine to the compressor, and are supported through a plurality of roller and/or ball bearing assemblies. At least some known bearing assemblies use a dynamic lubrication system that enables a lubricating fluid to be circulated through the bearing assembly. Furthermore, these known bearing assemblies use steel balls supported within paired steel rings. The problem: Balls constructed of steel are generally heavy and have a tendency to skid and/or cold weld to the paired steel races during thrust cross-over.

BRIEF DESCRIPTION

At least one solution for the above-mentioned problem(s) is provided by the present disclosure to include example embodiments, provided for illustrative teaching and not meant to be limiting.

In one aspect, a bearing assembly for use with a turbine engine is provided. The assembly includes an outer ring, an inner ring disposed coaxially within the outer ring, and a plurality of rolling elements engaged between the outer ring and the inner ring. The outer ring includes a drainage aperture defined therein and the inner ring includes a supply aperture defined therein. Furthermore, the plurality of rolling elements are constructed of a ceramic material.

An example bearing assembly for use with a turbine engine according to at least some aspects of the present disclosure may include an outer ring including a drainage aperture defined therein, the outer ring comprising a raceway contact surface that is generally shaped as a gothic arch; an inner ring disposed coaxially within said outer ring, said inner ring including a supply aperture defined therein, the inner ring comprising a raceway contact surface that is generally shaped as a gothic arch; and a plurality of rolling elements engaged between said outer ring and said inner ring. The rolling elements may be constructed of a ceramic material and/or the outer ring and the inner ring may be constructed of metal.

An example bearing assembly according to at least some aspects of the present disclosure may include an outer ring including a plurality of oil drainage apertures extending therethrough; an inner ring disposed axially within outer ring about a central axis, the inner ring including a plurality of oil supply apertures extending therethrough; and a plurality of ceramic rolling elements positioned between the outer ring and the inner ring to facilitate rotation of the inner ring with respect to the outer ring. The outer ring includes a first raceway contact surface in contact with the rolling elements. The first raceway contact surface may be generally in the shape of a gothic arch forming a first circumferential recess between the rolling elements and the first raceway contact surface. The inner ring includes a second raceway contact surface in contact with the rolling elements. The second raceway contact surface may be generally in the shape of a gothic arch forming a second circumferential recess between the rolling elements and the second raceway contact surface.

### BRIEF DESCRIPTION OF THE DRAWINGS

The subject matter for which patent claim coverage is sought is particularly pointed out and claimed herein. The subject matter and embodiments thereof, however, may be best understood by reference to the following description taken in conjunction with the accompanying drawing figures in which:

FIG. 1 is a cross-sectional view of an exemplary turbine engine;

FIG. 2 is a partial cutaway perspective view of an exemplary bearing assembly;

FIG. 3 is a sectional view of the bearing assembly shown in FIG. 2;

FIG. 4 is a cross-sectional view of the bearing assembly shown in FIG. 3 in a first operational mode;

FIG. 5 is a cross-sectional view of the bearing assembly shown in FIG. 3 in a second operational mode;

FIG. 6 is a cross-sectional view of the bearing assembly shown in FIG. 3 in a third operational mode; and

FIG. 7 is magnified view of contact surface asperities of the bearing assembly shown in FIG. 2, all in accordance with at least some aspects of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure includes, inter alia, gas turbine engines, and, more specifically, bearing assemblies for supporting turbine rotor shafts.

Embodiments of the present disclosure relate to the use of a four point contact drained outer race ball bearing assembly in combination with balls formed of a suitable ceramic material, such as silicon nitride (Si3N4). The four point contact geometry includes an outer race having an oil groove with drain holes to facilitate draining oil through the outer race during operation. Draining oil from the bearing assembly results in reduced viscous oil churning and less heat generation. Furthermore, the outer race and the inner race each include a gothic arch to prevent contact between the oil grooves and balls. As such, the gothic arch configurations on the outer and inner races facilitate initiating contact between the inner and outer races and the balls.

Generally, the four point contact hybrid bearing operates at three points of contact during normal operating conditions and four points of contact during thrust cross-over or low thrust operating conditions. In contrast, a traditional bearing assembly that only utilizes the gothic arch configurations on the inner race operates at two points of contact during normal operating conditions and three points of contact during thrust cross-over or low thrust operating conditions. The extra contact points increase the risk of skidding damage due to sliding between the balls and raceway. The example ceramic (e.g., silicon nitride) ball described herein reduces the risk of skidding and/or cold welding between the ball and raceway by constructing the balls and raceways of dissimilar materials. Furthermore, example ceramic (e.g., silicon nitride) balls are 40% as dense and thus 60% lighter than steel balls of similar size and are harder and have a 50% higher elastic modulus. As such, the example ceramic (e.g., silicon nitride) balls described herein reduce the risk of skidding damage, reduce the weight of the turbine engine, lower heat generation within the bearing assembly, improve hard particle contamination resistance, reduce the centrifugal load applied to the outer race during operation, and increase fatigue life of the turbine components.

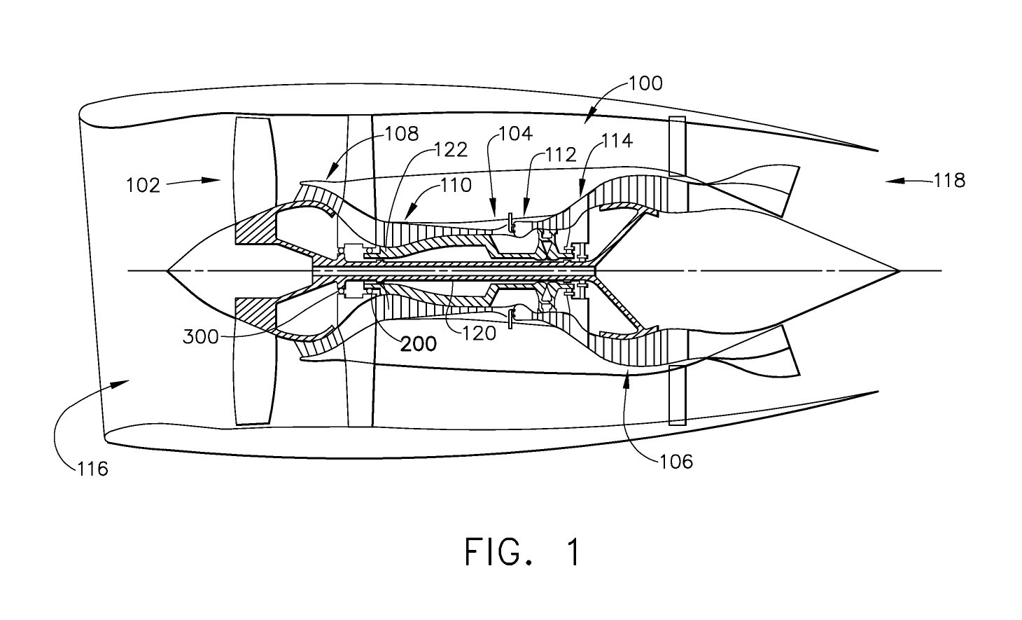

FIG. 1 is a cross-sectional view of a turbine engine 100. In the exemplary embodiment, turbine engine 100 includes, in series, a fan assembly 102, a core gas turbine engine section 104, and a low-pressure turbine 106. Furthermore, in the exemplary embodiment, core gas turbine section 104 includes a high-pressure compressor 110, a combustor 112, and a high-pressure turbine 114. Turbine engine 100 also includes an inlet 116 and an exhaust 118. Furthermore, in the exemplary embodiment, high-pressure compressor 110 includes a compressor shaft 122 and turbine engine 100 includes a shaft 120 extending therethrough.

Turbine engine 100 also includes a plurality of bearing assemblies configured to support high-pressure compressor 110 and low-pressure shaft 120. For example, in the exemplary embodiment, turbine engine 100 includes a first bearing assembly 200 coupled to high-pressure compressor shaft 122 and a second bearing assembly 300 coupled to low-pressure shaft 120. Bearing assemblies 200 and 300 are substantially similar and have a substantially annular configuration configured to circumscribe shaft 122 and 120, respectively.

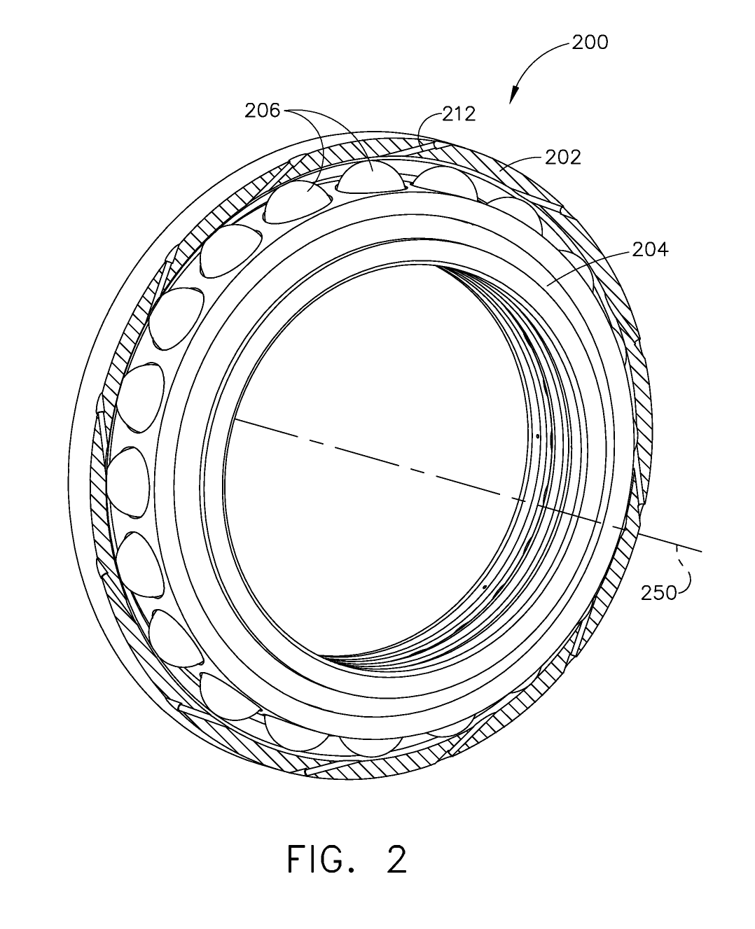

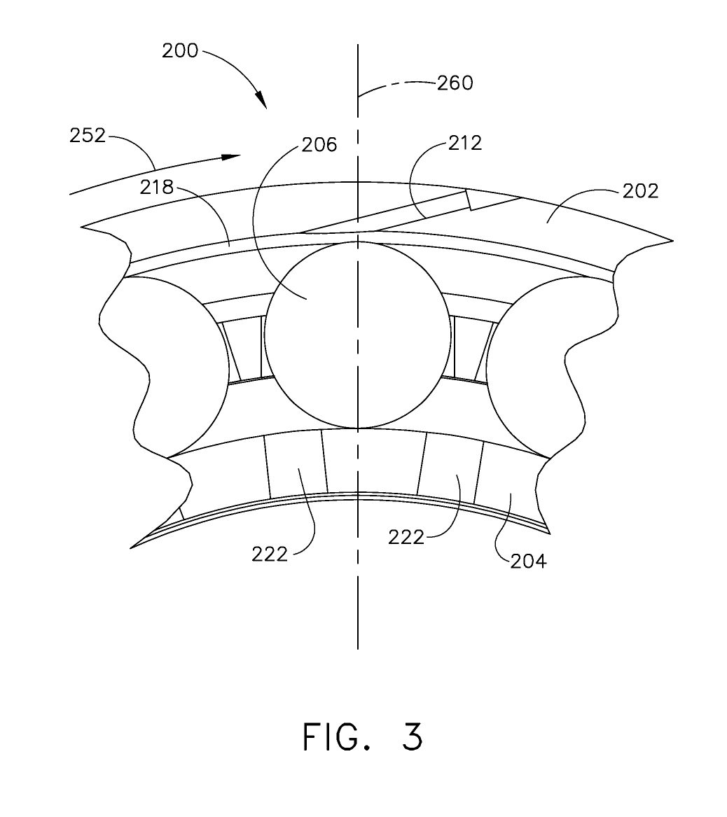

FIGS. 2 and 3 are a partially transparent perspective view and a cross-sectional view of bearing assembly 200. Although bearing assembly 200 will be described in more detail herein, it should be understood that the same description may apply to bearing assembly 300. In the exemplary embodiments, bearing assembly 200 includes an outer ring 202, an inner ring 204, and a plurality of rolling elements 206. Inner ring 204 is disposed coaxially within outer ring 202 about a central axis 250 and rolling elements 206 are positioned between outer ring 202 and inner ring 204. Furthermore, in the exemplary embodiment, inner ring 204 is sized and configured to receive shaft 122 (shown in FIG. 1) inserted therethrough. Rolling elements 206 are engaged between outer ring 202 and inner ring 204 to facilitate rotation of inner ring 204 about central axis 250.

Furthermore, in the exemplary embodiment, inner ring 204 includes a plurality of supply apertures 222 extending therethrough and outer ring 202 includes a plurality of drainage apertures 212 extending therethrough. Supply apertures 222 are configured to supply a flow of oil to bearing assembly 200 and drainage apertures 212 are configured to discharge oil from bearing assembly 200. As such, oil is continuously circulated through bearing assembly 200 to facilitate lubrication and heat rejection. In the exemplary embodiment, drainage apertures 212 are angled obliquely with respect to a radial axis 260 to facilitate the flow of oil through drainage apertures 212. More specifically, drainage apertures 212 extend through outer ring 202 in a direction of a rotation 252 of rolling elements 206. Furthermore, in the exemplary embodiment, supply apertures 222 extend through inner ring 204 substantially perpendicularly with respect to central axis 250. In an alternative embodiment, supply apertures 222 may extend through inner ring 204 at an angle to the direction of rotation 252 of rolling elements 206 to facilitate encouraging oil circulation within bearing assembly 200.

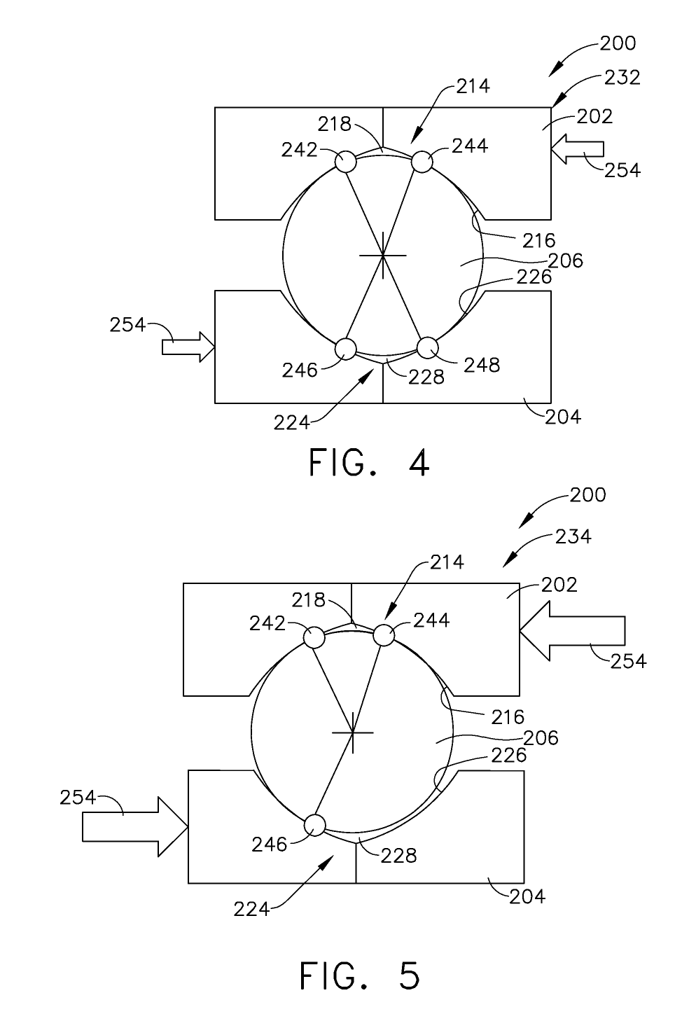

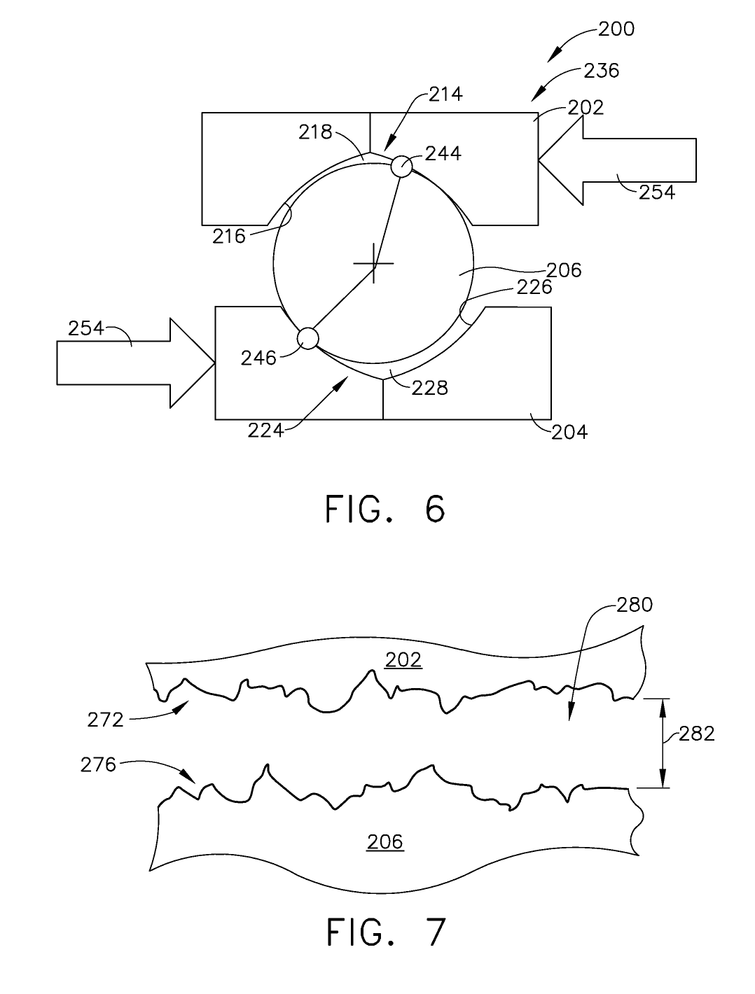

FIGS. 4, 5, and 6 are cross-sectional views of bearing assembly 200 in a first operational mode 232, a second operational mode 234, and a third operational mode 236. More specifically, first operational mode 232 illustrates bearing assembly 200 in a no/low thrust load operating condition, second operational mode 234 illustrates bearing assembly 200 in a medium thrust load operating condition, and third operational mode 236 illustrates bearing assembly 200 in a high thrust load operating condition.

In the exemplary embodiment, outer ring 202 includes a first gothic arch 214 and a first raceway contact surface 216, and inner ring 204 includes a second gothic arch 224 and a second raceway contact surface 226. Rolling element 206 is positioned between outer ring 202 and inner ring 204 such that rolling element 206 contacts at least a portion of first raceway contact surface 216 and second raceway contact surface 226. Furthermore, in the exemplary embodiment, gothic arch 214 forms a first circumferential recess 218 between rolling element 206 and contact surface 216, and gothic arch 224 forms a second circumferential recess 228 between rolling element 206 and contact raceway surface 226. As such, circumferential recesses 218 and 228 enable lubricating oil to flow therethrough and through apertures 212 and 222 by at least partially separating rolling element 206 from contact raceway surfaces 216 and 226.

Furthermore, in the exemplary embodiment, when bearing assembly 200 is in first operational mode 232, rolling element 206 and outer and inner rings 202 and 204 are in four points of contact. For example, bearing assembly 200 in first operational mode 232 includes a first contact point 242, a second contact point 244, a third contact point 246, and a fourth contact point 248. Furthermore, in the exemplary embodiment, as thrust load 254 increases, bearing assembly 200 in second operational mode 234 includes first contact point 242, second contact point 244, and third contact point 246, and bearing assembly 200 in third operational mode 236 includes second contact point 244 and third contact point 246.

In the exemplary embodiments, rolling element 206 is a ball constructed of any suitable ceramic material and, for example, rolling element 206 may be constructed from silicon nitride (Si₃N₄). As mentioned above, an example ceramic (e.g., silicon nitride) rolling element 206 is 60% lighter and has a 50% higher elastic modulus than steel rolling elements of similar size and configuration. The extent of contact between rolling element 206 and outer and inner rings 202 and 204 may be determined by the curvature of first raceway contact surface 216 and second raceway contact surface 226. However, it should be understood that ceramic (e.g., silicon nitride) rolling element 206 may have any suitable diameter such that bearing assembly 200 functions as described herein.

Furthermore, the ceramic (e.g., silicon nitride) balls have the ability to resist damage from hard particles that may be present in bearing assembly 200. More specifically, hard particles present in the oil used to lubricate bearing assembly 200 contact rolling elements 206 during turbine engine operation. Example ceramic materials (e.g, silicon nitride) have a Rockwell hardness of approximately 80 (RC80), which is harder than bearing steel having Rockwell hardness ranges of between about 58 (RC58) to about 68 (RC68). As such, the ceramic (e.g., silicon nitride) material facilitates preventing deformation of rolling elements 206 as rolling elements 206 roll over hard particles during operation.

FIG. 7 is magnified view of contract surface asperities of bearing assembly 200. In the exemplary embodiment, using ceramic (e.g., silicon nitride) rolling elements 206 in combination with a steel outer ring 202 and a steel inner ring 204 (shown in FIG. 2) facilitates reducing the risk of skidding damage and cold welding between rolling elements 206 and outer and inner rings 202 and 204. Contact between rolling element 206 and outer ring 202 will be described in detail. However, it should be understood that the description may also apply to the contact between rolling element 206 and inner ring 204. In the exemplary embodiment, rolling elements 206 include first asperities 276 and outer ring 202 includes second asperities 272. During operation, an oil film 280 is located between rolling element 206 and outer ring 202 to facilitate separating rolling element 206 from outer race 202. However, during certain operating conditions, a thickness 282 of oil film 280 may be insufficient to separate rolling element 206 and outer ring 202. As such, when rolling element 206 and outer ring 202 are constructed from similar materials, i.e. steel, asperities 272 contact rolling element 206 and asperities 276 contact outer ring 202 resulting in the transfer of material therebetween. In the exemplary embodiment, when rolling element 206 is constructed of a suitable ceramic materal (e.g., silicon nitride) and outer ring 202 is constructed of steel, the dissimilar materials have a reduced likelihood of surface adhesion resulting in the transfer of material therebetween such that skidding damage is facilitated to be reduced.

The ceramic rolling elements described herein facilitate improving the performance characteristics of known dynamic lubrication bearing assemblies.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A bearing assembly for use with a turbine engine, the bearing assembly comprising:
an outer ring comprising an oil drainage aperture defined therein;
an inner ring disposed coaxially within the outer ring, the inner ring comprising an oil supply aperture defined therein; and
a plurality of rolling elements engaged between the outer ring and the inner ring, wherein the plurality of rolling elements are constructed of a ceramic material.

2. The bearing assembly of claim 1,
wherein the outer ring and the inner ring are constructed of metal; and
wherein the ceramic material is harder than the outer ring and the inner ring.

3. The bearing assembly of claim 1, wherein the ceramic material comprises silicon nitride (Si₃N₄).

4. The bearing assembly of claim 1,
wherein the outer ring comprises a first raceway contact surface that is generally shaped as a gothic arch forming a first circumferential recess between the plurality of rolling elements and the outer ring; and
wherein the inner ring comprises a second raceway contact surface that is generally shaped as a gothic arch forming a second circumferential recess between the plurality of rolling elements and the inner ring.

5. The bearing assembly of claim 1,
wherein, in a first operation mode under relatively low thrust conditions, an individual one of the plurality of rolling elements, the outer ring, and the inner ring are in four point contact;
wherein, in a second operational mode under moderate thrust conditions, an individual one of the plurality of rolling elements is in two point contact with the outer ring and is in one point contact with the inner ring; and
wherein, in a third operational mode under relatively high thrust conditions, an individual one of the plurality of rolling elements is in one point contact with the outer ring and is in one point contact with the inner ring.

6. The bearing assembly of claim 1, wherein the drainage apertures are angled obliquely with respect to a radial axis and extend through the outer ring in a direction of rotation of the rolling elements.

7. The bearing assembly of claim 1, wherein the supply apertures extend through the inner ring substantially perpendicularly with respect to the central axis.

8. A bearing assembly for use with a turbine engine, the bearing assembly comprising:
an outer ring comprising a drainage aperture defined therein, the outer ring comprising a raceway contact surface that is generally shaped as a gothic arch;
an inner ring disposed coaxially within said outer ring, said inner ring comprising a supply aperture defined therein, the inner ring comprising a raceway contact surface that is generally shaped as a gothic arch; and
a plurality of rolling elements engaged between said outer ring and said inner ring;
wherein said plurality of rolling elements are constructed of a ceramic material; and
wherein the outer ring and the inner ring are constructed of metal.

9. The bearing assembly of claim 8, wherein the ceramic material comprises silicon nitride (Si₃N₄).

10. The bearing assembly of claim 8,
wherein, in a first operation mode under relatively low thrust conditions, an individual one of the plurality of rolling elements, the outer ring raceway contact surface, and the inner ring raceway contact surface are in four point contact;
wherein, in a second operational mode under moderate thrust conditions, an individual one of the plurality of rolling elements is in two point contact with the outer ring raceway contact surface and is in one point contact with the inner ring raceway contact surface; and
wherein, in a third operational mode under relatively high thrust conditions, an individual one of the plurality of rolling elements is in one point contact with the outer ring raceway contact surface and is in one point contact with the inner ring raceway contact surface.

11. The bearing assembly of claim 8,
wherein a first circumferential recess is disposed between the plurality of rolling elements and the outer ring; and
wherein a second circumferential recess is disposed between the plurality of rolling elements and the inner ring.

12. A bearing assembly comprising:
an outer ring comprising a plurality of oil drainage apertures extending therethrough;
an inner ring disposed axially within outer ring about a central axis, the inner ring comprising a plurality of oil supply apertures extending therethrough; and
a plurality of ceramic rolling elements positioned between the outer ring and the inner ring to facilitate rotation of the inner ring with respect to the outer ring;
wherein the outer ring comprises a first raceway contact surface in contact with the plurality of rolling elements, the first raceway contact surface being generally in the shape of a gothic arch forming a first circumferential recess between the plurality of rolling elements and the first raceway contact surface;
wherein the inner ring comprises a second raceway contact surface in contact with the plurality of rolling elements, the second raceway contact surface being generally in the shape of a gothic arch forming a second circumferential recess between the plurality of rolling elements and the second raceway contact surface.

13. The bearing assembly of claim 12,
wherein the plurality of ceramic rolling elements comprise silicon nitride (Si₃N₄); and
wherein the inner ring and the outer ring comprise steel.

14. The bearing assembly of claim 12, wherein the plurality of ceramic rolling elements are harder than the outer ring and the inner ring.

15. The bearing assembly of claim 12, wherein the drainage apertures are angled obliquely with respect to a radial axis.

16. The bearing assembly of claim 12, wherein the drainage apertures extend through the outer ring in a direction of rotation of the rolling elements.

17. The bearing assembly of claim 12, wherein the supply apertures extend through the inner ring substantially perpendicularly with respect to the central axis.

18. The bearing assembly of claim 12, wherein the supply apertures extend through the inner ring in a direction generally perpendicular to a direction of rotation of the rolling elements.

19. The bearing assembly of claim 12,
wherein, in a first operation mode under relatively low thrust conditions, an individual one of the plurality of rolling elements, the outer ring, and the inner ring are in four point contact;
wherein, in a second operational mode under moderate thrust conditions, an individual one of the plurality of rolling elements is in two point contact with the outer ring and is in one point contact with the inner ring; and
wherein, in a third operational mode under relatively high thrust conditions, an individual one of the plurality of rolling elements is in one point contact with the outer ring and is in one point contact with the inner ring.
